(19) United States
(12) Patent Application Publication
(10) Pub. No.: US 2025/0385634 A1
(43) Pub. Date: Dec. 18, 2025

(54) Solar Panel Clip and Tool

(71) Applicant: A.K. Stamping Company, Inc., Mountainside, NJ (US)

(72) Inventors: Arthur Kurz, Mountainside, NJ (US); Joshua Kurz, Chester, NJ (US); Andrew Nino, North Bergen, NJ (US); Ahmed Nabil Awad, Paterson, NJ (US)

(73) Assignee: A.K. Stamping Company, Inc., Mountainside, NJ (US)

(21) Appl. No.: 19/239,650

(22) Filed: Jun. 16, 2025

Related U.S. Application Data
(60) Provisional application No. 63/660,255, filed on Jun. 14, 2024.
(60) Provisional application No. 63/802,254, filed on May 8, 2025.

(51) Int. Cl. H02S 20/20; F24S 25/60; F24S 25/61

(52) U.S. Cl. CPC H02S 20/20; F24S 25/61; F24S 2025/6004

(57) ABSTRACT

A solar clip is provided having a body with an upstanding surface above the body and depending surfaces below the body. Stops extend between the upstanding surface and the depending surfaces, and an engagement arm extends from the body to above the upstanding surface. The solar clip is formed by stamping. The solar clip includes first and second long edges, and first and second short edges, and the first and second long edges may be hemmed or curled; one upwardly and the other downwardly. A solar clip tool includes a handle, removable attachable guide rods at one side of the handle, a removably attachable prong at the same side of the handle, and a tool interface at the opposite side of the handle. The guide rods can be removed and replaced with grips.

### RELATED APPLICATIONS

This application claims priority to U.S. Provisional Application Ser. No. 63/660,255 filed on Jun. 14, 2024, and U.S. Provisional Application Ser. No. 63/802,254 filed on May 8, 2025, the entire disclosures of which are hereby expressly incorporated by reference.

### BACKGROUND

### Field of the Disclosure

The present disclosure relates generally to a clip for a solar panel.

### Related Art

Solar clips can be used to attach solar panels to an array by securing brackets attached to the solar panel to a rail on a structure or array.

### SUMMARY

A solar clip has a body with a perimeter. An upstanding surface extends above the body and one or more depending surfaces extend below the body. One or more stops extend between the upstanding surface and the depending surface. An engagement arm can extend from the body to above the upstanding surface.

The one or more stops are separated from the upstanding surface and arc to contact one of the one or more depending surfaces. The one or more stops further comprise a long portion and a tab that extends from an outer edge forming a notch. The tab contacts the one of the one or more depending surfaces and the outer edge of the long portion extends alongside one of the one or more depending surfaces. The solar clip is formed by stamping and the tabs on the long portions of the stops correspond to recesses in the depending surfaces.

The solar clip includes first and second long edges, and first and second short edges, and the first and second long edges may be hemmed or curled; one upwardly and the other downwardly. The solar clip may have one or more depending surfaces that are attached to the body by first and second depending angled arms. An engagement arm can extend from the body and includes a first surface, an articulated segment and a knuckle extending above the upstanding surface. The engagement arm can be positioned between two portions of the upstanding angled arms of the upstanding portion at an insertion end of the clip, the body includes apertures at the insertion end for receiving clip tools.

A solar clip tool includes a handle, removable attachable guide rods at one side of the handle, a removably attachable prong at the same side of the handle, and a tool interface at the opposite side of the handle. The guide rods are parallel, as is the prong. The guide rods can be removed and replaced with grips.

### BRIEF DESCRIPTION OF THE DRAWINGS

The foregoing features of the invention will be apparent from the following Detailed Description of the Invention, taken in connection with the accompanying drawings, in which:

FIG. 1 is a perspective view of a solar clip according to the present disclosure.

FIG. 2 is a top view of the clip shown in FIG. 1.

FIG. 3 is a side view of the clip shown in FIG. 1.

FIG. 4 is an end view of the clip shown in FIG. 1.

FIG. 5 is a perspective view of the clip shown in FIG. 1, positioned in a bracket.

FIG. 6 is another perspective view of the clip and bracket shown in FIG. 5.

FIG. 7 is a side view of a solar panel bracket attached to a rail with the clip shown in FIG. 1.

FIG. 8 is a close-up sectional view of the solar panel attached to a rail.

FIG. 9 is a perspective view of a solar clip according to the present disclosure.

FIG. 10 is a top view of the clip shown in FIG. 9.

FIG. 11 is a side view of the clip shown in FIG. 9.

FIG. 12 is a front end view of the clip shown in FIG. 9.

FIG. 13 is a perspective view of the clip shown in FIG. 9, positioned in a bracket.

FIG. 14 is another perspective view of the clip and bracket shown in FIG. 13.

FIG. 15 is a side view of a solar panel bracket attached to a rail with the clip shown in FIG. 9.

FIG. 16 is a close-up view of the clip shown in FIG. 13.

FIG. 17 is a perspective view of another solar clip according to the present disclosure.

FIG. 18 is a top view of the clip shown in FIG. 17.

FIG. 19 is a side view of the clip shown in FIG. 17.

FIG. 20 a front end view of the clip shown in FIG. 17.

FIG. 21 perspective view of the clip shown in FIG. 17, positioned in a bracket.

FIG. 22 is another perspective view of the clip and bracket shown in FIG. 21.

FIG. 23 is a side view of a solar panel bracket attached to a rail with the clip shown in FIG. 17.

FIG. 24 is a close-up view of the clip shown in FIG. 21.

FIG. 25 is an end view of the clip shown in FIG. 17.

FIGS. 26-29 are perspective views of a clip insertion and removal tool.

### DETAILED DESCRIPTION

The present disclosure relates to a solar panel clip, as discussed in detail below.

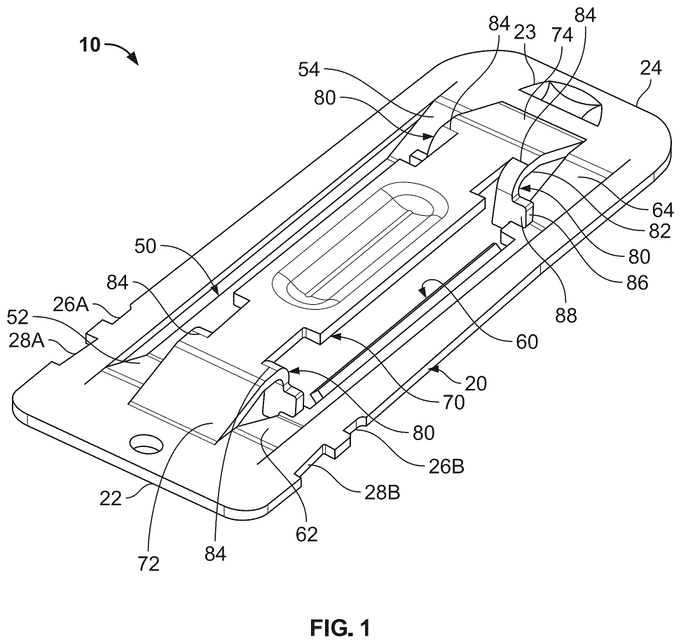

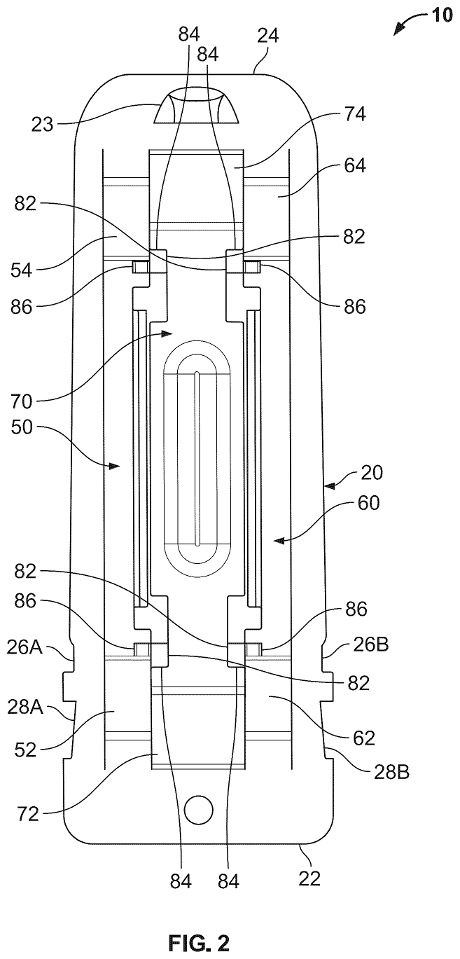

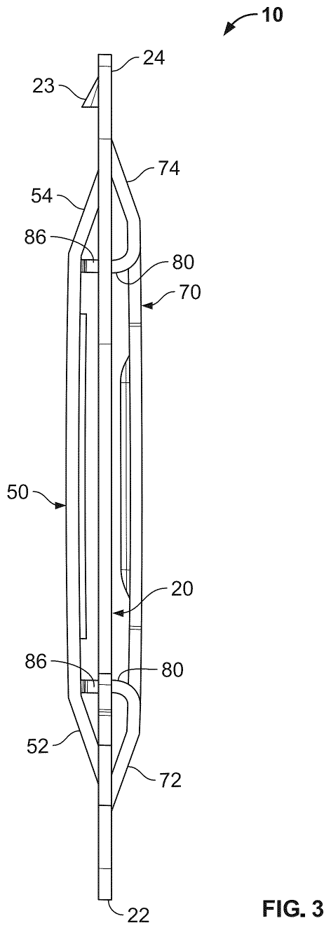

Generally referring to FIGS. 1-4, a solar clip 10 is shown for attaching solar rails and frames. The clip 10 has a peripheral outer body 20 including a base 22 and a forward tab 24 within the outer body 20. A detent 23 is provided on the forward tab 24. Extending between the base 22 and the forward tab 24 are three elongate, planar, parallel sections, namely, first outer section 50, second outer section 60 and central section 70. Each of the first and second outer sections 50 and 60 and central section 70 include angled areas at the connection points with the base 22 and the forward tab 24, respectively, such that the sections 50, 60, and 70 are positioned above or below the plane of the clip 10 as defined by peripheral outer body 20.

Central section 70 is upwardly displaced from the plane of the clip 10 and the first and second outer sections 50 and 60 are downwardly displaced from the plane of the clip 10. Central section 70 is connected to the base 22 by first angled arm 72 and to the forward tab 24 by second angled arm 74 to position the central section 70 above the plane of the clip 10. First and second outer sections 50 and 60 are connected to the base 22 by angled arms 52 and 62 and to the forward tab 24 by angled arms 54 and 64 to position the first and second sections 50 and 60 below the plane of the clip 10. The angled arms 52, 62 and 72 and 54, 64 and 74 provide flexibility to the clip 10 to form a compressible assembly. When placed between surfaces, the clip and be elastically compressed to fit between such surfaces and engage such surfaces for the purpose of making mechanical contact between the surfaces, namely, between a solar panel bracket and a mounting rail on a ground structure. However, mechanical stops as will be discussed, limit such compressibility. The peripheral outer body 20 includes retention notches 26a and 26b, and gripping notches 28a and 28b on outer edges of the peripheral outer body 20.

Notches 26a and 26b are positioned proximate the base 22 to engage edges of the frames/rails to lock the clip 10 into position. The clip 10 is put into position by sliding it in place between upper and lower surfaces that can compress the clip. The clip 10 can be removed by gripping at notches 28a and 28b and pulling the clip 10 to withdraw it from the engaged position.

Central section 70 includes a plurality of fingers 80 that include material partially separate from the central section 70 and separated from an outer section 50, 60. More specifically, the fingers 80 have a long portion 82 starting at attachment 84 and separated from the central portion along the length thereof, and a tab 86 comprised of material from the outer sections 50, 60 extending from the long portion 82. The long portion 82 and the tab 86 forming a notch 88 that engages the outer sections 50, 60, the tab sitting on the outer sections 50, 60 to limit compression of the clip 10. The tab 86 is stamped from the outer sections 50, 60. The fingers 80 are bent down from a point of attachment 84 with central section 70 such that the tab 86 bears against the upper surfaces of the outer sections 50 and 60 to maintain the separation between the central section 70 and the outer sections 50 and 60 and add structural rigidity to the clip 10. Fingers 80 extend from being co-planar with central section 70 at one end, to perpendicular to outer sections 50 and 60 at the other end. Four such fingers could be used, two for each outer section 50 and 60, one located for each toward the base 22 and one toward the forward tab 24.

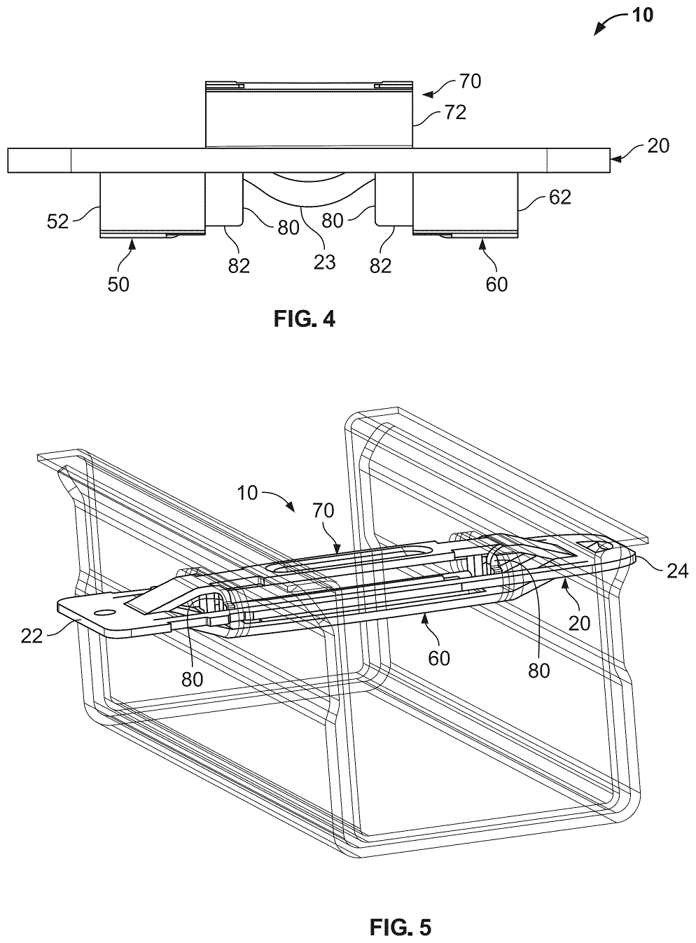

The clip 10 is installed by pushing it through corresponding slots in a rail and a bracket. A knife (not shown) extends under the clip and engages the detent 23, shown in FIG. 4, to assist sliding the clip into position.

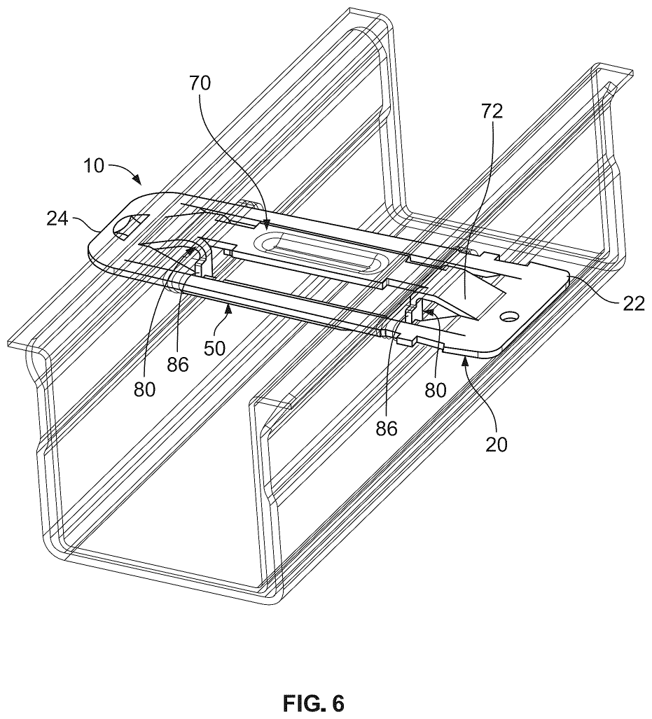

As shown in FIGS. 5 and 6, the clip 10 is positioned in corresponding slots in a frame and bracket to secure a solar panel to a structure or array. The central section 70 bears against upper edges of slots. First and second outer sections 50 and 60 bear against lower edges of the slot. Notches 26a and 26b bear against sides of the slots to lock the clip 10 to the frame and bracket.

The clip material could be metal such as steel that may be heat-treatable and the surface could be treated to prevent corrosion. For example, heat treated steel or stainless steel could be used. The clip can be made of a carbon steel, which can be hardened and tempered.

The clip 10 according to the present disclosure can be manufactured by stamping. The clip 10 can be manufactured in a progressive die. The three parallel sections of the central portion along with the peripheral outer body 20 can be sheared in the tool resulting in no loss of material between each of these members. Additionally, the fingers 80 can be partially separated from the central section 70 and the tabs 86 can be fully separated from the outer sections 50 and 60. In the next operation the three center members 50, 60, and 70 are formed simultaneously, resulting in the proper parallel offset required, and the fingers 80 can be bent from central section 70 to be in position to bear against outer sections 50 and 60. The angled portions of sections 50, 60 and 70 add tension to the clip 10.

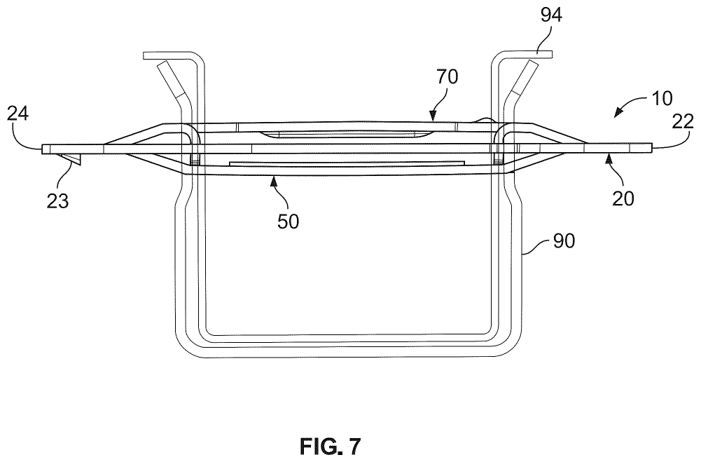

As shown in FIG. 7, a solar panel has a bracket which fits into a frame or rail and is attached thereto with clip 10.

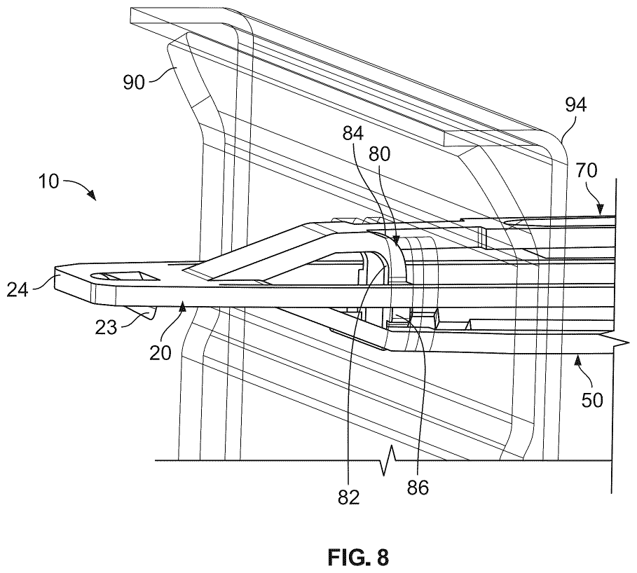

FIG. 8 is a close up of clip 10 extending through slots in rail 90 (on a structure or array) and in bracket 94 (attached to a solar panel). Central section 70 bears against upper edges of the slot and outer sections 50 and 60 (not shown) bear against the bottom edges of the slots. Fingers 80 are bent from the central section at 84 and long portions 82 are bent down such that tabs 86 bear against the outer sections 50 and 60 (not shown) to provide mechanical stops.

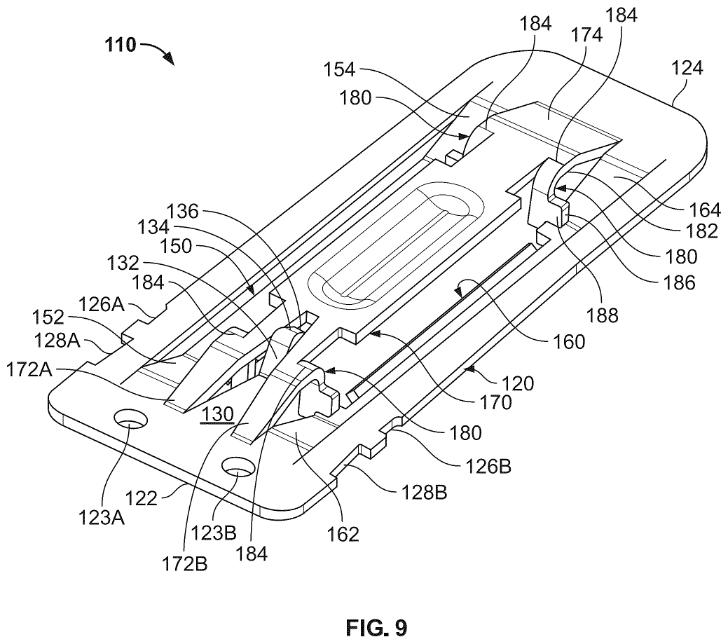

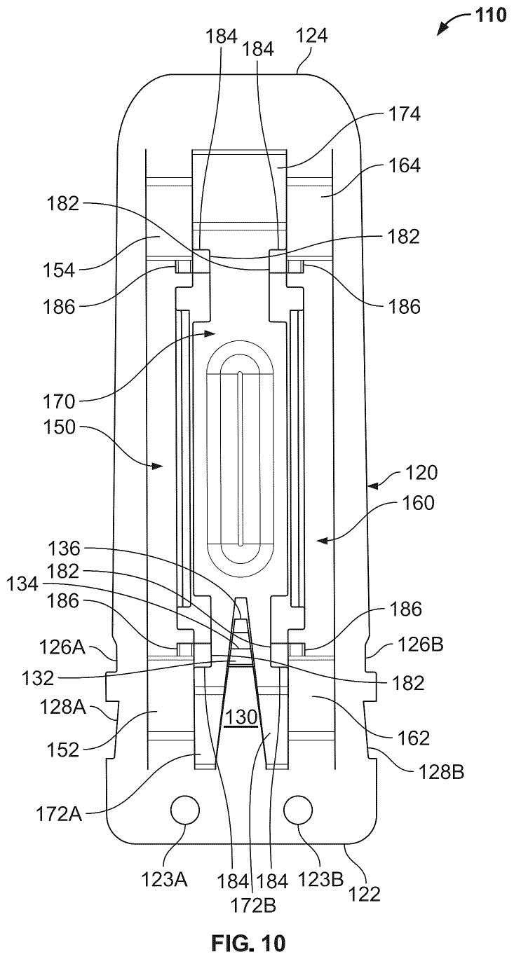

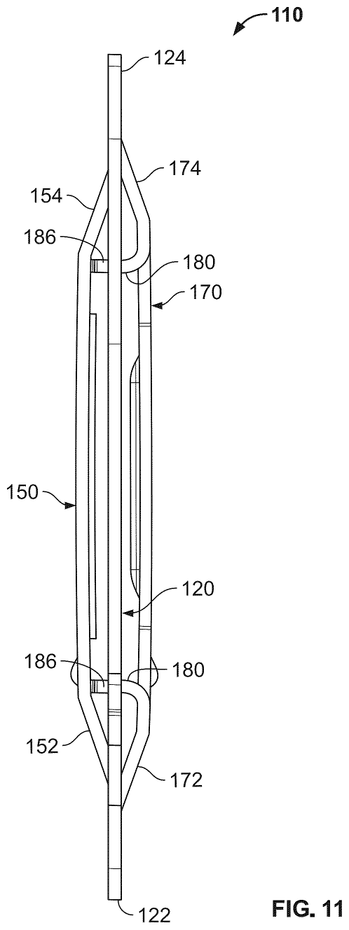

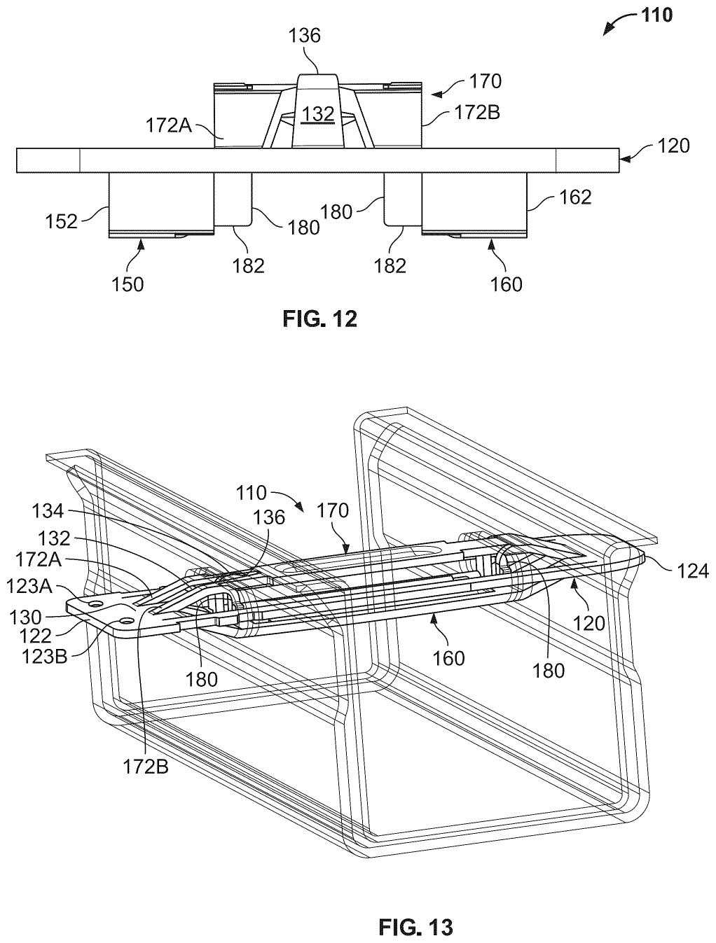

Generally referring to FIGS. 9-12, a solar clip 110 is shown for attaching solar rails and frames. The clip 110 has a peripheral outer body 120 including a base 122 and a forward tab 124 within the outer body 120. Extending between the base 122 and the forward tab 124 are three elongate, planar, parallel sections, namely, first outer section 150, second outer section 160 and central section 170. Each of the first and second outer sections 150 and 160 and central section 170 include angled areas at the connection points with the base 122 and the forward tab 124, respectively, such that the sections 150, 160, and 170 are positioned above or below the plane of the clip 110 as defined by peripheral outer body 120.

Central section 170 is upwardly displaced from the plane of the clip 110 and the first and second outer sections 150 and 160 are downwardly displaced from the plane of the clip 110. Of course, this could be varied and one or more elongate sections can be utilized in either direction. Central section 170 is connected to the base 122 by first angled arms 172A and 172B and to the forward tab 124 by second angled arm 174 to position the central section 170 above the plane of the clip 110. Between first and second angled arms 172A and 172B is engagement arm 130, that can be generally in plane with outer body 120. Engagement arm 130 is separated from angled arms 172A and 172B and includes articulated segment 132 that stands up from engagement arm 130, and angled portion 134 with a knuckle portion 136. The configuration of engagement arm 130 can be varied but knuckle 136 extends above the plane of elongate section 170 to secure clip 110 in position as will be hereinafter discussed.

First and second outer sections 150 and 160 are connected to the base 122 by angled arms 152 and 162 and to the forward tab 124 by angled arms 154 and 164 to position the first and second sections 150 and 160 below the plane of the clip 110. The angled arms 152, 162 and 172A and 172B, and 154, 164 and 174 provide flexibility to the clip 10 to form a compressible assembly. When placed between surfaces, the clip can be elastically compressed to fit between such surfaces and engage such surfaces for the purpose of making mechanical contact between the surfaces, namely, between a solar panel bracket and a mounting rail on a ground structure. However, mechanical stops, as will be discussed, limit such compressibility. The peripheral outer body 120 includes retention notches 126a and 126b, and gripping notches 128a and 128b on outer edges of the peripheral outer body 120.

Notches 126a and 126b may be included and are positioned proximate the base 122 where they may engage edges of the frames/rails to help lock the clip 110 into position. The clip 110 is put into position by sliding it in place between upper and lower surfaces that can compress the clip. The clip 110 can be removed by gripping at notches 128a and 128b and pulling the clip 110 to withdraw it from the engaged position.

Central section 170 includes a plurality of fingers 180 that include material partially separated from the central section 170 and separated from an outer section 150, 160. More specifically, the fingers 80 have a long portion 182 starting at attachment 184 and separated from the central portion along the length thereof, and a tab 186 comprised of material from the outer sections 150, 160 extending from the long portion 182. The long portion 182 and the tab 186 forming a notch 188 that engages the outer sections 150, 160, the tab sitting on the outer sections 150, 160 to limit compression of the clip 110. The tab 186 is stamped from the outer sections 150, 160. The fingers 180 are bent down from a point of attachment 184 with central section 170 such that the tab 186 bears against the upper surfaces of the outer sections 150 and 160 to maintain the separation between the central section 170 and the outer sections 150 and 160 and add structural rigidity to the clip 110. Fingers 180 extend from being co-planar with central section 170 at one end, to perpendicular to outer sections 150 and 160 at the other end. Four such fingers could be used, two for each outer section 150 and 160, one located for each toward the base 122 and one toward the forward tab 124.

The clip 110 is installed by pushing it through corresponding slots in a rail and a bracket. A knife (not shown) or tool(s) as described herein, can be used to assist inserting the clip into position, and removing the clip. Apertures 123A and 123B are provided for the tool(s) to interconnect with the clip, as needed.

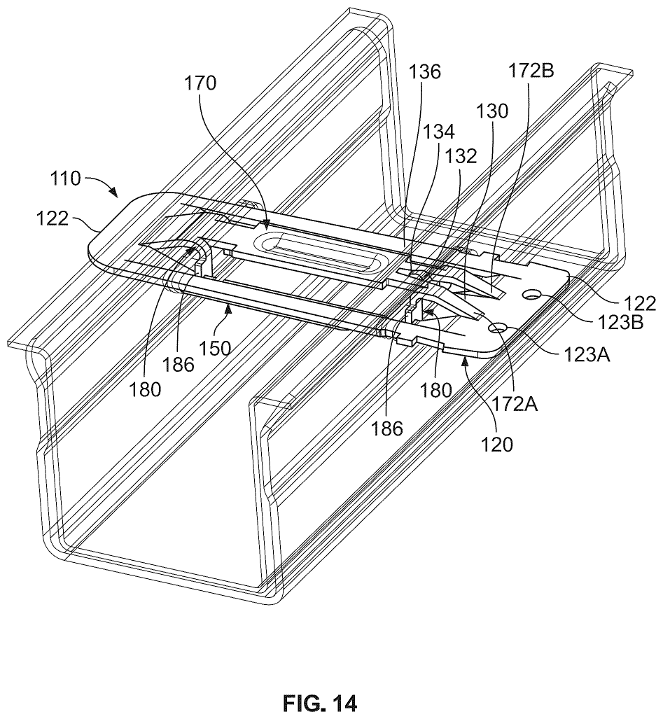

As shown in FIGS. 13 and 14, the clip 110 is positioned in corresponding slots in a frame and bracket to secure a solar panel to a structure or array. The central section 170 bears against upper edges of slots. First and second outer sections 150 and 160 bear against lower edges of the slot. Knuckle 136 bears against bracket 194 to lock the clip 110 to the frame and bracket.

The clip material could be metal such as steel that may be heat-treatable and the surface could be treated to prevent corrosion. For example, heat treated steel or stainless steel could be used. The clip can be made of a carbon steel, which can be hardened and tempered.

The clip 110 according to the present disclosure can be manufactured by stamping. The clip 110 can be manufactured in a progressive die. The three parallel sections of the central portion along with the peripheral outer body 120 can be sheared in the tool resulting in no loss of material between each of these members. Additionally, the engagement arm 130 and the fingers 180 can be partially separated from the central section 170 and the tabs 186 can be fully separated from the outer sections 50 and 60. In the next operation the three center members 150, 160, and 170 are formed simultaneously, resulting in the proper parallel offset required, and the fingers 180 can be bent from central section 170 to be in position to bear against outer sections 150 and 160. Likewise, the engagement arm segments 132, 134 and knuckle 136 can be bent. The angled portions of sections 150, 160 and 170 add tension to the clip 110.

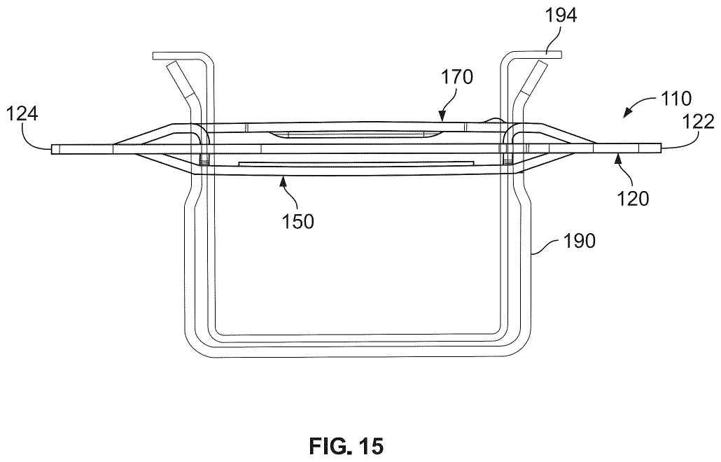

As shown in FIG. 15 a solar panel has a bracket which fits into a frame or rail and is attached thereto with clip 110. As can be seen, knuckle 136 extends past the bracket 194 to retain the clip 110 in position.

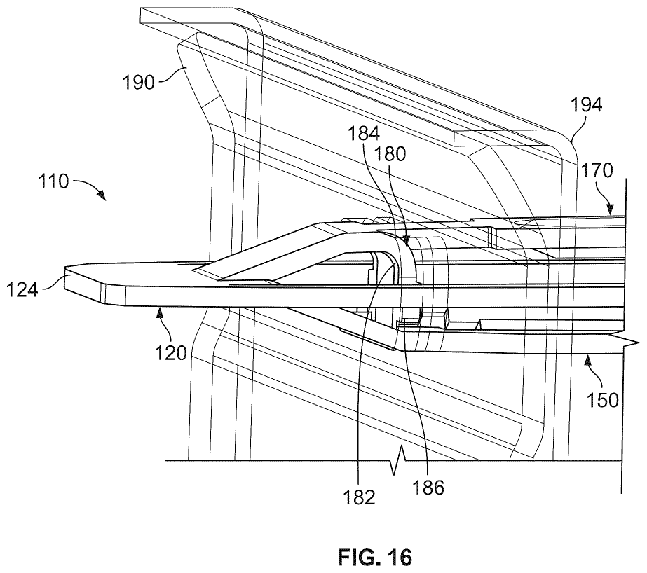

FIG. 16 is a close up of clip 110 extending through slots in rail 190 (on a structure or array) and in bracket 194 (attached to a solar panel). Central section 170 bears against upper edges of the slot and outer sections 150 and 160 (not shown) bear against the bottom edges of the slots. Fingers 180 are bent from the central section at 184 and long portions 182 are bent down such that tabs 186 bear against the outer sections 150 and 160 (not shown) to provide mechanical stops.

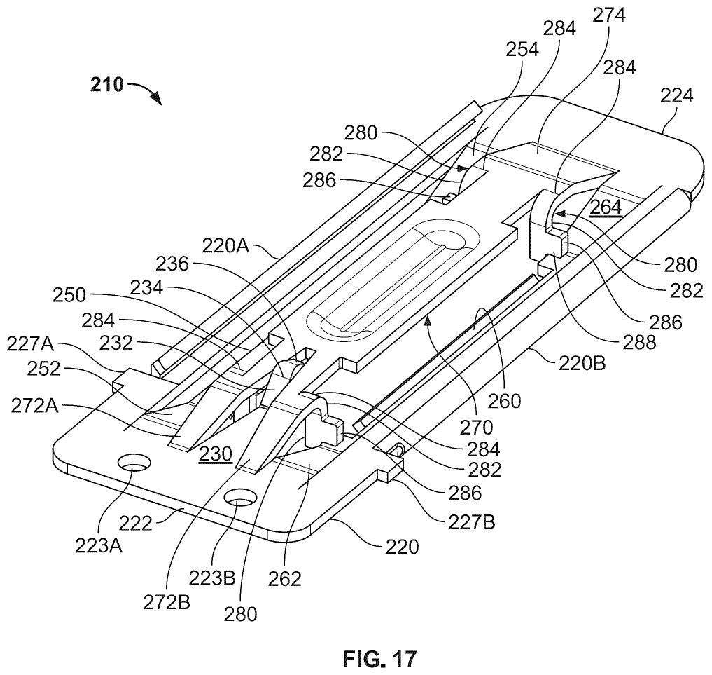

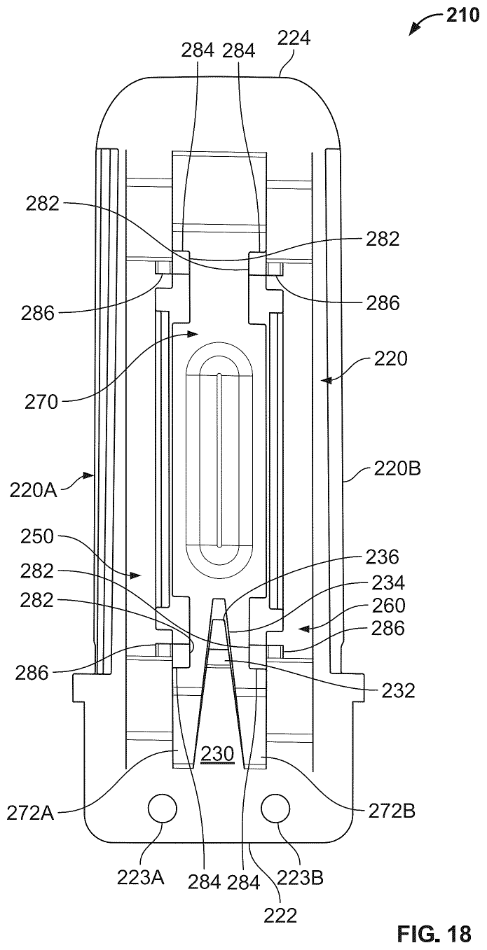

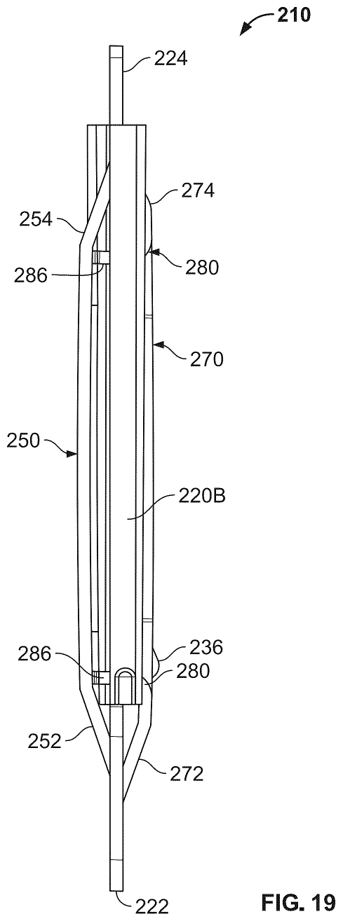

Generally referring to FIGS. 17-20, a solar clip 210 is shown for attaching solar rails and frames. The clip 210 has a peripheral outer body 220 including a base 222 and a forward tab 224 within the outer body 220. Edges 220A and 220B of the outer body are rolled or curved or hemmed to allow rotational movement of a solar panel with respect to a bracket. Extending between the base 222 and the forward tab 224 are three elongate, planar, parallel sections, namely, first outer section 250, second outer section 260 and central section 270. Each of the first and second outer sections 250 and 260 and central section 270 include angled areas at the connection points with the base 222 and the forward tab 224 respectively, such that the sections 250, 260 and 270 are positioned above or below the plane of the clip 210 as defined by peripheral outer body 220.

Central section 270 is upwardly displaced from the plane of the clip 210 and the first and second outer sections 250 and 260 are downwardly displaced from the plane of the clip 210. Of course, this could be varied and one or more elongate sections can be utilized in either direction. Central section 270 is connected to the base 222 by first angled arms 272A and 272B and to the forward tab 224 by second angled arm 274 to position the central section 270 above the plane of the clip 210. Between first and second angled arms 272A and 272B is engagement arm 230 in plane with outer body 220. Engagement arm 230 is separated from angled arms 272A and 272B and includes an articulated segment 232 that stands up from engagement arm 230, and an angled portion 234 with a knuckle portion 236. The configuration of engagement arm 230 can be varied but knuckle 236 extends above the plane of elongate section 270 to secure clip 210 in position as will be hereinafter discussed.

First and second outer sections 250 and 260 are connected to the base 222 by angled arms 252 and 262 and to the forward tab 224 by angled arms 254 and 264 to position the first and second sections 250 and 260 below the plane of the clip 210. The angled arms 252, 262 and 272A and 272B, and 254, 264 and 274 provide flexibility to the clip 210 to form a compressible assembly. When placed between surfaces, the clip can be elastically compressed to fit between such surfaces and engage such surfaces for the purpose of making mechanical contact between the surfaces, namely, between a solar panel bracket and a mounting rail on a ground structure. However, mechanical stops, as will be discussed, limit such compressibility. The peripheral outer body 220 includes prongs 227A and 227B on outer edges of the peripheral outer body 220.

Central section 270 includes a plurality of fingers 280 that include material partially separate from the central section 270 and separated from an outer section 250, 260. More specifically, the fingers 280 have a long portion 282 starting at attachment 284 and separated from the central portion along the length thereof, and a tab 286 comprised of material from the outer sections 250, 260 extending from the long portion 282. The long portion 282 and the tab 286 forming a notch 288 that engages the outer sections 250, 260, the tab sitting on the outer sections 250, 260 to limit compression of the clip 210. The tab 286 is stamped from the outer sections 250, 260. The fingers 280 are bent down from a point of attachment 284 with central section 270 such that the tab 286 bears against the upper surfaces of the outer sections 250 and 260 to maintain the separation between the central section 270 and the outer sections 250 and 260 and add structural rigidity to the clip 210. Fingers 280 extend from being co-planar with central section 270 at one end, to perpendicular to outer sections 250 and 260 at the other end. Four such fingers could be used, two for each outer section 250 and 260, one located for each toward the base 222 and one toward the forward tab 224.

The clip 210 is installed by pushing it through corresponding slots in a rail and a bracket. A knife (not shown) or tool(s) as described herein, can be used to assist inserting the clip into position, and removing the clip. Apertures 223A and 223B are provided for the tool(s) to interconnect with the clip, as needed.

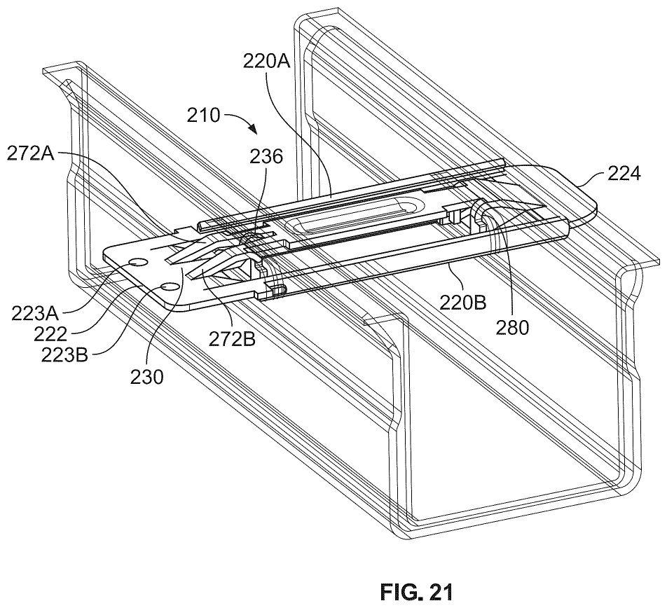

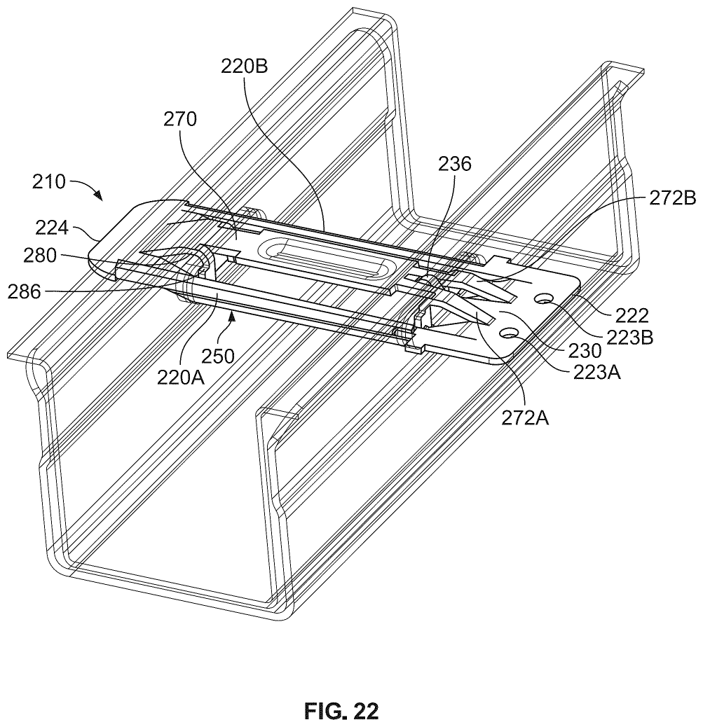

As shown in FIGS. 21 and 22, the clip 210 is positioned in corresponding slots in a frame and bracket to secure a solar panel to a structure or array. The central section 270 bears against upper edges of slots. First and second outer sections 250 and 260 bear against lower edges of the slot.

The clip material could be metal such as steel that may be heat-treatable and the surface could be treated to prevent corrosion. For example, heat treated steel or stainless steel could be used. The clip can be made of a carbon steel, which can be hardened and tempered.

The clip 10, 110, 210 according to any of the aspects of the present disclosure can be manufactured by stamping. The clip 10, 110, 210 can be manufactured in a progressive die. The three parallel sections of the central portion along with the peripheral outer body can be sheared in the tool resulting in no loss of material between each of these members. Additionally, the arm 130, 230 and the fingers 80, 180, 280 can be partially separated from the central section 70, 170, 270 and the tabs 86, 186, 286 can be fully separated from the outer sections 50, 150, 250 and 60, 160, 260. In the next operation the three center members 50, 150, 250; 60, 160, 260; and 70, 170, 270 are formed simultaneously, resulting in the proper parallel offset required, and the fingers 80, 180, 280 can be bent from central section 70, 170, 270 to be in position to bear against outer sections 50, 150, 250 and 60, 160, 260. Likewise, the engagement arm segments 132, 232, 134, 234 and 136, 236 can be bent. The angled portions of sections 50, 150, 250; 60, 160, 260; and 70, 170, 270 add tension to the clip 10, 110, 210.

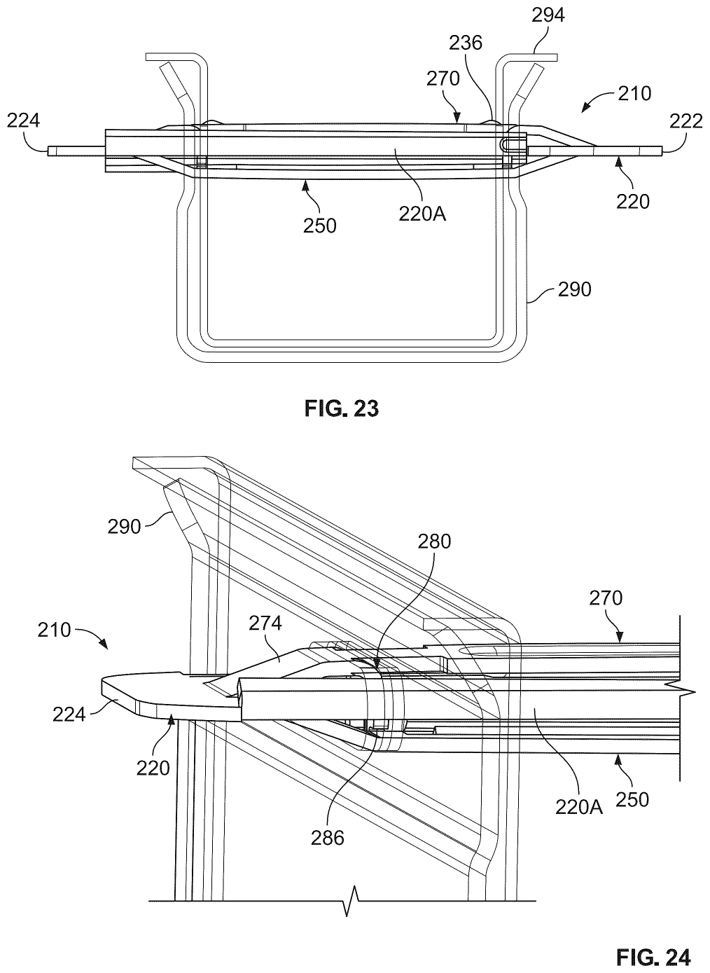

As shown in FIG. 23, a solar panel has a bracket which fits into a frame or rail and is attached thereto with clip 210. As can be seen, knuckle 236 extends past the bracket 294 to retain clip 210 in position.

FIG. 24 is a close up of clip 210 extending through the slots in rail 290 (on a structure or array) and in bracket 294 (attached to a solar panel). Central section 270 bears against upper edges of the slot and outer sections 250 and 260 (not shown) bear against the bottom edges of the slots. Fingers 280 are bent from the central section at 284 and long portions 282 are bent down such that tabs 286 bear against the outer sections 250 and 260 (not shown) to provide mechanical stops.

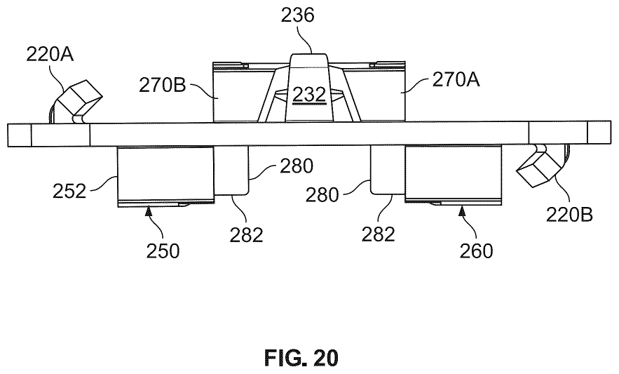

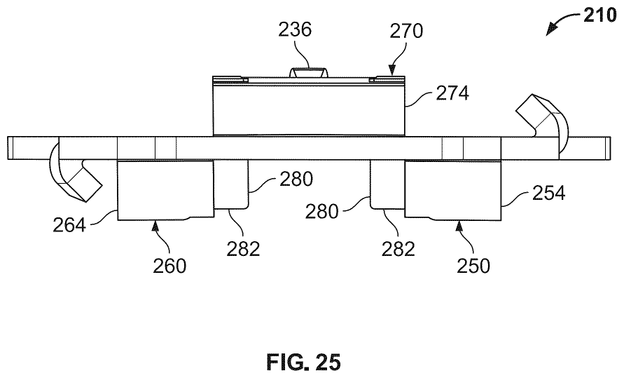

FIG. 25 is a similar view of clip 210 as FIG. 20 but from the opposite end, showing knuckle 236, central section 270 first and second sections 250 and 260, angled arms 252, 262 and 272 fingers 280 with long portions 282

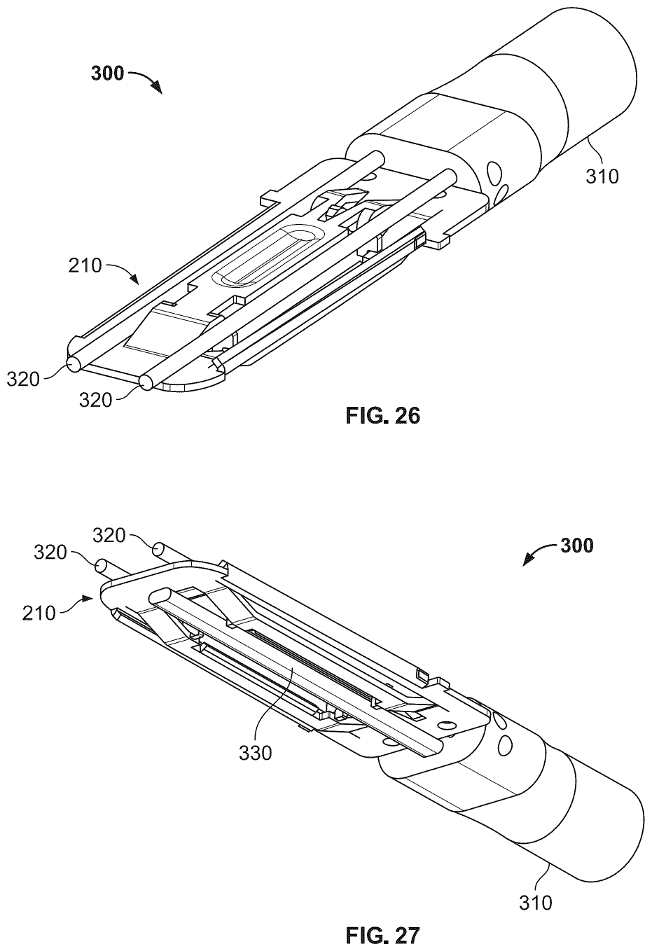

FIGS. 26 and 27 show an insertion and removal tool, generally indicated at 300, having a handle 310, guide rods 320 and prong 330. The guide rods 320 and prong 330 are removably attached to the handle 310. The guide rods 320 and 330 engage a solar clip 10, 110, 210 for insertion into a rail and bracket to secure a rail and bracket together, and thus secure a solar panel, attached to a bracket, to a rail.

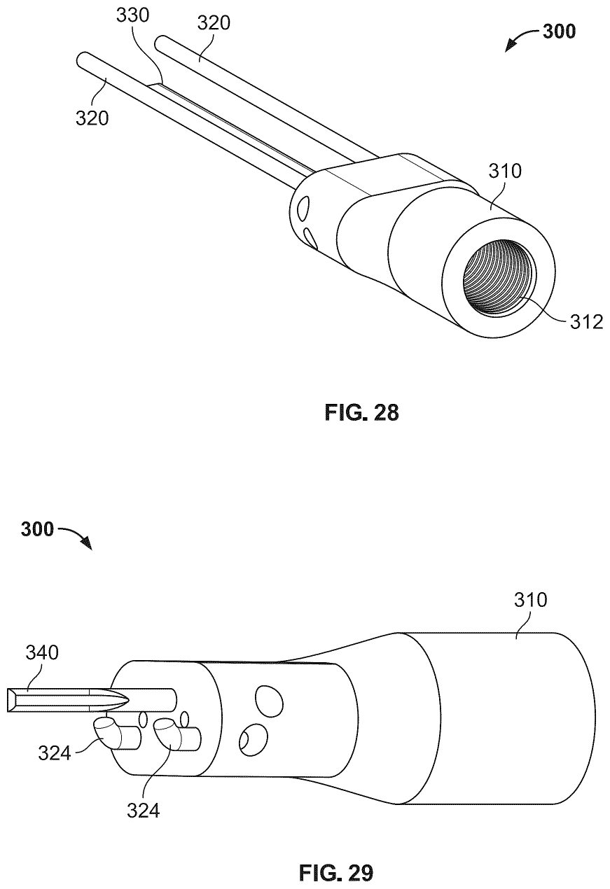

FIG. 28 shows another view of tool 300 and shows a tool interface 312 to which another tool, not shown, can be attached. The tool interface 312 can be an internally threaded cylinder.

FIG. 29 shows tool 300 reconfigured with prong 340 and grips 324. Prong 340 depresses knuckle 136, 236 and grips 324 engage apertures 123A and 123B or 223A and 223B to remove the clip from engagement.

Having thus described the disclosure in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

What is claimed is:

1. A solar clip having:
a body with a perimeter;
an upstanding surface extending above the body;
one or more depending surfaces extending below the body;
one or more stops extending between the upstanding surface and the depending surface; and
an engagement arm extending from the body to above the upstanding surface.

2. The solar clip of claim 1 wherein the one or more stops comprises a portion of the upstanding surface arced to contact one of the one or more depending surfaces.

3. The solar clip of claim 2 wherein the one or more stops further comprise a long portion and a tab extending from an outer edge forming a notch, the tab contacting one of the one or more depending surfaces and the outer edge of the long portion extending alongside one of the one or more depending surfaces.

4. The solar clip of claim 3 wherein the one or more depending surfaces comprises two depending surfaces, one positioned on each side of the upstanding surface.

5. The solar clip of claim 4 wherein the one or more stops comprises two stops positioned at each end of the upstanding surface.

6. The solar clip of claim 5 wherein the clip is formed by stamping and the tabs on the long portions of the stops correspond to recesses in the depending surfaces.

7. The solar clip of claim 1 wherein the body includes first and second long edges, and first and second short edges, and the first and second long edges are curled.

8. The solar clip of claim 7 wherein one of the first or second long edges are upwardly curved and the other of the first or second long edges are downwardly curved.

9. The solar clip of claim 1 wherein the upstanding surface is attached to the body by first and second upstanding angled arms.

10. The solar clip of claim 9 wherein the one or more depending surfaces are attached to the body by first and second depending angled arms.

11. The solar clip of claim 4 wherein each depending surface includes first and second depending angled arms.

12. The solar clip of claim 11 wherein the body is located in plane between planes formed by the upstanding surface and the depending surfaces.

13. The solar clip of claim 12 the engagement arm extending from the body includes a first surface, an articulated segment and a knuckle extending above the upstanding surface.

14. The solar clip of claim 13 wherein the engagement arm is positioned between two portions of the upstanding angled arms of the upstanding portion.

15. The solar clip of claim 14 wherein the engagement arm is positioned at an insertion end of the clip.

16. The solar clip of claim 15 wherein the perimeter of the body includes apertures at the insertion end for receiving clip tools.

17. A solar clip tool comprising:
a handle;
removable attachable guide rods at one side of the handle;
a removably attachable prong at the same side of the handle; and
a tool interface at the opposite side of the handle.

18. The solar clip tool of claim 17 wherein guide rods are parallel.

19. The solar clip handle of claim 18 wherein the prong is parallel to the guide rods.

20. The solar clip handle of claim 17 wherein the interface comprises an internally threaded cylinder.

21. The solar clip handle of claim 19 wherein grips replace the guide rods.

22. The solar clip handle of claim 21 wherein the guide rods have a first segment parallel to a long axis of the handle and a second segment at an angle thereto.
